(19) United States
(12) Patent Application Publication
(10) Pub. No.: US 2004/0006500 A1
(43) Pub. Date: Jan. 8, 2004

(54) Method and apparatus for solution design, implementation, and support

(76) Inventor: Diego Guicciardi, Houston, TX (US)

Correspondence Address: Jonathan P. Osha, ROSENTHAL & OSHA L.L.P., Suite 2800, 1221 McKinney Street, Houston, TX, 77010, US

(21) Appl. No.: 10/190,991

(22) Filed: Jul. 8, 2002

(51) Int. Cl. G06F 17/60

(52) U.S. Cl. 705/7

(57) ABSTRACT

A method for designing a solution includes building archival tables of information for a plurality of particular types of solution sites; preparing archival architectural maps for each of the plurality of particular types of solution sites; defining archival organization hierarchies for each of the plurality of particular types of solution sites; forming a solution database containing the archival tables of information, the archival architectural maps, and the archival organization hierarchies; surveying a new solution site to determine a particular type of the new solution site; and designing the solution based on the particular type of the new solution site using the solution database.

### BACKGROUND OF INVENTION

In technical consulting, integrated solutions are developed to manage secure connectivity centers, wireless and remote network access, and rapid application development for real time data handling. A combination of technical consulting with network management services allows secure access to global networking channels. The convergence of networks, data, and applications has accelerated with the introduction of IP (Internet Protocol) networks and wireless applications. Combined with smart cards and PKI technologies, there are virtually no limits to the ways corporations can perform their business-critical transactions in real-time, anytime, anyplace.

Technical flexibility, however, comes with significant risk and demands careful planning, foresight, and field-proven knowledge of both the problems and possibilities involved. In today's fast-paced communication market, corporations turn to value-added service providers to develop situation and goal oriented solutions. In developing these solutions, value-added service providers rely on consultants who have been trained to evaluate an existing corporate structure and current business constraints to create a solution that aligns the corporation with their envisioned ultimate goal.

### SUMMARY OF INVENTION

In general, in one aspect, the present invention involves a method for designing a solution comprising building archival tables of information for a plurality of particular types of solution sites. The archival tables of information comprise an assets list table describing assets deployed to each particular type of solution site; and a site notebook describing activities involved with deployment of the assets to each particular type of solution site. The method comprising preparing archival architectural maps for each of the plurality of particular types of solution sites, the archival architectural maps describing operational connections among the assets deployed to each of the plurality of particular types of solution sites; defining archival organization hierarchies for each of the plurality of particular types of solution sites, the archival organizational hierarchies describing roles and responsibilities for personnel involved in the development of each of the plurality of particular types of solution sites, deployment of each of the plurality of particular types of solution sites, and support of each of the plurality of particular types of solution sites; forming a solution database containing the archival tables of information, the archival architectural maps, and the archival organization hierarchies; surveying a new solution site to determine a particular type of the new solution site; and designing the solution based on the particular type of the new solution site using the solution database.

In general, in one aspect, the present invention involves an apparatus for facilitating design of a solution comprising archival tables of information for a plurality of particular types of solution sites. The archival tables of information comprise an assets list table describing assets deployed to each particular type of solution site; and a site notebook describing activities involved with deployment of the assets to each particular type of solution site. The apparatus comprising archival architectural maps for each of the plurality of particular types of solution sites, the archival architectural maps describing operational connections among the assets deployed to each of the plurality of particular types of solution sites; archival organization hierarchies for each of the plurality of particular types of solution sites, the archival organizational hierarchies describing roles and responsibilities for personnel involved in the development of each of the plurality of particular types of solution sites, deployment of each of the plurality of particular types of solution sites, and support of each of the plurality of particular types of solution sites; and a solution database containing the archival tables of information, the archival architectural maps, and the archival organization hierarchies. The solution is designed, based on a particular type of the new solution site determined by a survey of the new solution site, using the solution database.

Other aspects and advantages of the invention will be apparent from the following description and the appended claims.

### BRIEF DESCRIPTION OF DRAWINGS

FIG. 1 is a block diagram of an exemplary system in accordance with an embodiment of the present invention.

FIG. 2 is a graph representing a network in accordance with an embodiment of the present invention.

FIG. 3 is a flow chart of site table building process in accordance with an embodiment of the present invention.

FIG. 4 is an exemplary site table in accordance with an embodiment of the present invention.

FIG. 5 is an exemplary site table in accordance with an embodiment of the present invention.

FIG. 6 is an exemplary site table in accordance with an embodiment of the present invention.

FIG. 7 is a block diagram of a global organizational hierarchy in accordance with an embodiment of the present invention.

FIG. 8 is a block diagram of a site organizational hierarchy in accordance with an embodiment of the present invention.

FIG. 9 shows an exemplary application of the solution life cycle methodology to network related solutions.

FIG. 10 is a flow chart describing a network related solution development process in accordance with an embodiment of the present invention.

FIG. 11 is a flow chart describing a solution preparation process in accordance with an embodiment of the present invention.

### DETAILED DESCRIPTION

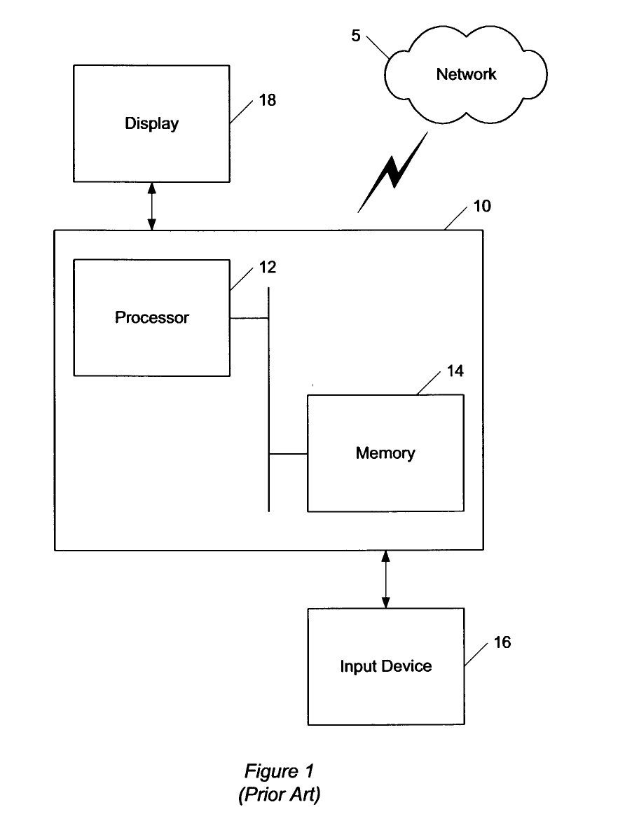

The present invention involves a method and apparatus for solution design, implementation, and support. Referring to the drawings, wherein like reference characters are used for like parts throughout the several views, FIG. 1 shows an exemplary system in accordance with an embodiment of the present invention. The invention described herein may involve any computer regardless of the platform being used.

For example, as shown in FIG. 1, a typical computer (10) has a processor (12), associated memory (14), and numerous other elements and functionalities typical to today's computers (not shown). The computer (10) has associated therewith an input device (16), such as a keyboard, touch screen, or the like. The computer (40) is also associated with a display device (18), such as a monitor, LCD screen, or the like. Finally, the computer (10) may be connected to a network (5), such as a LAN (local area network), WAN (wide area network), or the like. One well-known, global network is the Internet. As one skilled in the art will appreciate, the computer (10) may be a desktop, laptop, handheld, etc. and may access the network (5) via cable, fiber optics, wireless connection, etc.

An exemplary methodology in accordance with one or more embodiments of the invention is presented below and referred to as the “solution life cycle” methodology. The solution life cycle methodology includes organizational and technological components. From a technical standpoint, aspects of the solution life cycle involve building tables of key information for a particular site that will ultimately form a solution database. The solution database comprises the site information tables and dynamically updating information, such as troubleshooting, replacement/upgrade strategies, etc. On the organizational side, the solution life cycle presents a personnel hierarchy for the entire course of development, deployment, and support.

For efficient solution design, development, and support, all network information should be accessible to those involved with the process. This access should reach as far as possible from, for example, a single web interface that is functional and strongly modular. Such an interface is feasible thanks to Internet-based technologies which enable, using hyperlinks, to group logically what might be physically distant, i.e., on different hosts or databases. This concept is discussed in more detail below and will become clearer when considered in conjunction with the following methodologies.

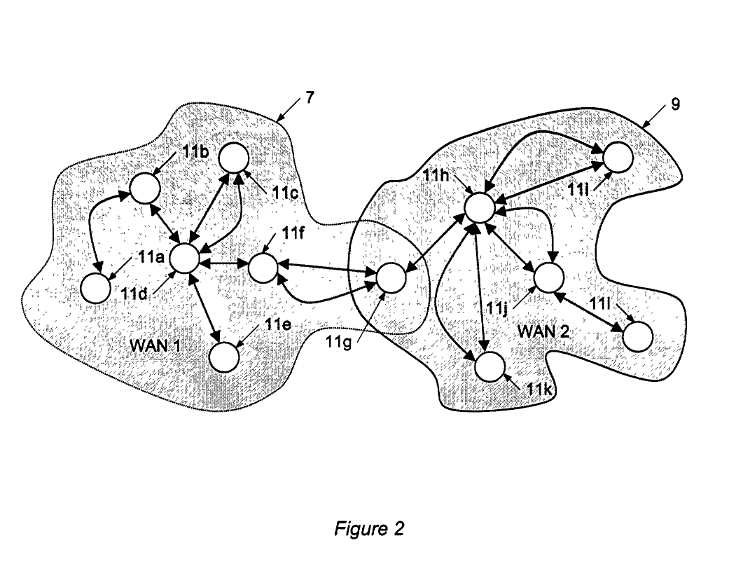

Referring to FIG. 2, a network can be seen as a graph composed of nodes and arcs. As can be seen, different networks, e.g., WAN 1 (7) and WAN 2 (9), may overlap at a given node (11g). That is, each node (11a . . . 1) may be part of one or more networks. In the set of nodes shown (11a . . . 1), some are connected to others by one or more mono-directional or bi-directional arrows. These interconnected nodes depict a general “network topology” in which the nodes (11a . . . 1) represent geographical sites and the arcs represent the network links between them.

The topology of a graph can also be described by tables. The table should include general information such as a network operations center (NOC) package, routing plan, and periodic network performance report. In the routing plan, all routing choices are described and justified. The periodic network performance report contains standard performance indexes/verifications to be used as a list of indexes/checklist of verifications. In order to create uniformity in the information collected, a template should be prepared for a generic network. The process for building a generic network template is similar to the process described below for a site. The general network information table is complemented by tables describing each of the single independent components that are part of the graph, i.e., the nodes and arcs.

Nodes contain the “static” network information. To each node, a list of information is associated. This static information may include a list of network elements and node related procedures. Note that an individual network element may be part of several networks. For each network element is hyperlinked to related information. A list of node related procedures, if any, are written and stored in the documents database. The list will be composed of simple hyperlinks to the actual procedure location.

Arcs between nodes contain “dynamic” network information. This information might include real-time performance data, periodic link performance reports, and the like. In this way, all types of incidents are stored in the same location without the need of doing any data entry. Also, the performance reports document standard performances indexes/verifications (to be a list of indexes/a checklist of verifications).

The nodes (11a . . . 11l) represent individual sites. For each site, a set of site tables is prepared. The site tables capture each phase of a site over the course of its life cycle and help generate information that will be used in following phases. Site tables are an efficient way to store this information once, in a pre-defined, well-known, easy to access, unique place where it will be readily available for future projects.

The foundation for the site tables lies in the following principles: Any network related solution can be modeled on a distributed site by site basis (WAN (wide area network), VPN (virtual private network), PKI (Public Key Infrastructure), client server applications, network security, etc.); And, any network related solution can be associated to a well defined set of site types (main office site/remote office site, client site/server site, etc.). Any network related solution has a global life cycle that is replicated locally, on a site-by-site basis (requirements analysis→design→implementation→support).

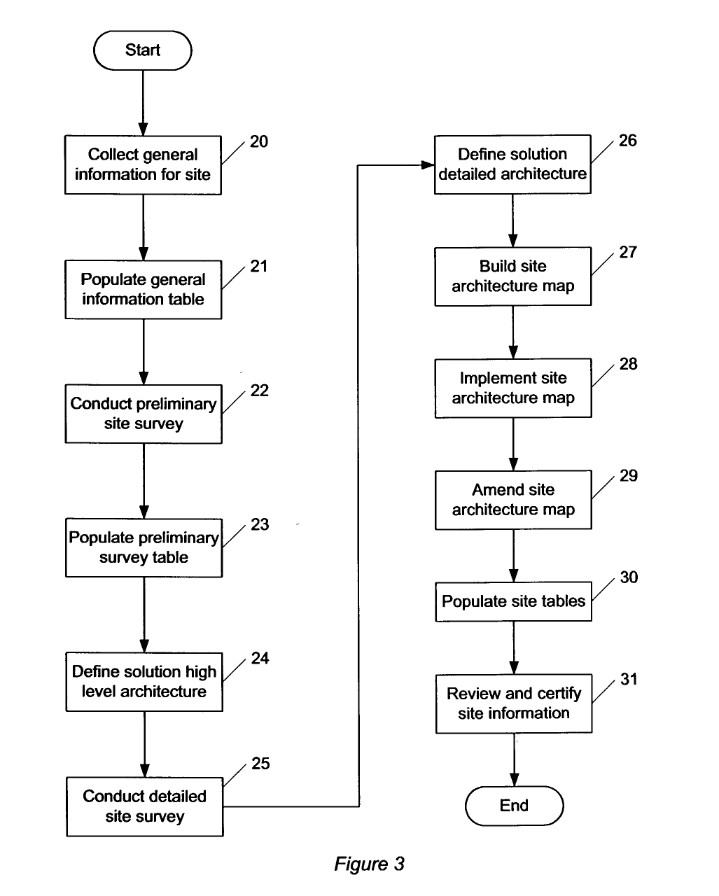

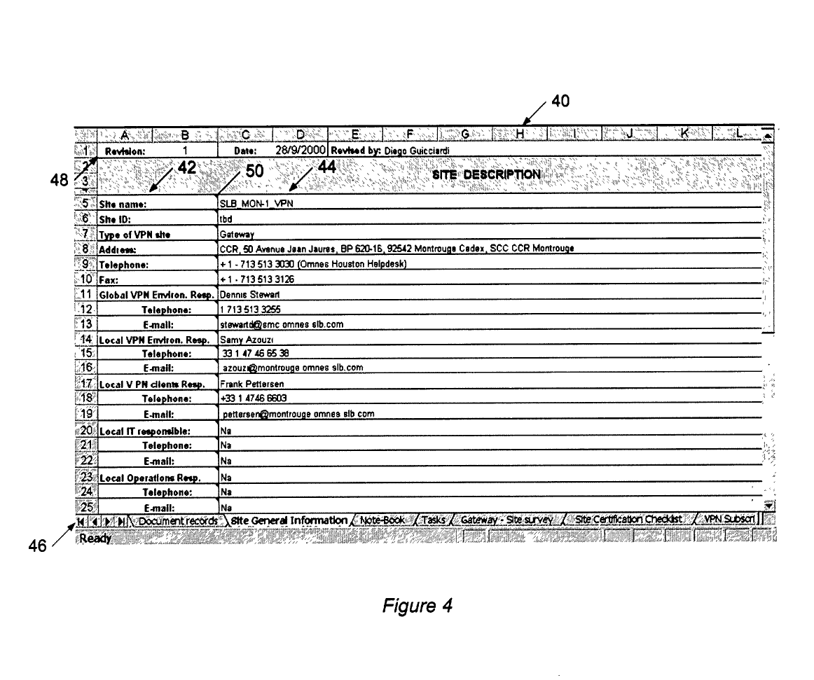

The site table building process proceeds as described below with reference to FIG. 3. For each provided network related solution, first, general information (location, contacts, etc.) for each type of site are collected (step 20) and put into a site general information table (step 21). An exemplary sheet for a VPN solution is shown in FIG. 4 and described below. This table will be used (read/write) by all the members of the “Solution Team.”

Any networked IT solution (WAN, PKI, VPN, etc.) is a network of well defined types of sites. However, when initially going to a new customer, the information about the customer's site is unknown. Thus, in the Site Tables, no matter what type of site, there must be the same preliminary survey table that contains questions whose answers will allow the Global Design Architects to assign a typology to each site from a big picture viewpoint. The big picture viewpoint focuses on the collection of all preliminary surveys coming from all customers locations.

In order to build the preliminary survey table, someone who knows the generic architecture and technology of the overall solution (WAN, VPN, PKI . . . ) considers what information the Global Design Architects will need to know about each generic location in order to be able to determine the type of a particular location. From this consideration, a set of questions and representative data points are created and stored in the preliminary survey table. The preliminary survey table is filled by the Site Team on-site (step 23) and returned to the Global Design Architects who will use it during the Solution High Level Architecture definition for a particular customer (step 24).

When the Solution High Level Architecture is defined, it should be possible to identify one or more different typologies of site (e.g., in a WAN you can have “Main office” type of site and the “Remote office” type of site). Then, for each type of site identified, a Detailed Site Survey should be built. This Detailed Site Survey shall contain questions that will help the Global Design Architects to create a detailed design for the site. The basic principle is that same type of sites will have the same (or, at least, similar) design, which requires specific information in order to be customized for a particular location. The Detailed Site Survey shall contain questions that will be asked by the Site Team deployed at the location in order to collect the important information about the site.

The Detailed Site Survey table should be prepared by someone that knows how a site of a given type should be designed and implemented. In this way, after populating the Detailed Site Survey, it is relatively easy for a Site Architect to customize a standard site design for a particular type of site in order to fit with a particular location. Usually, the Detailed Site Survey for a given type of site will be prepared by an expert solution architect and by an expert Service Delivery manager that can foresee potential troubles of implementing specific elements in the field. This allows problems during the site installation phase to be avoided. The Detailed Site Survey is conducted by the Site Team (on site) (step 25) and returned to the Global Design Architects who will use it to define the Detailed Architecture for a particular customer site (step 26).

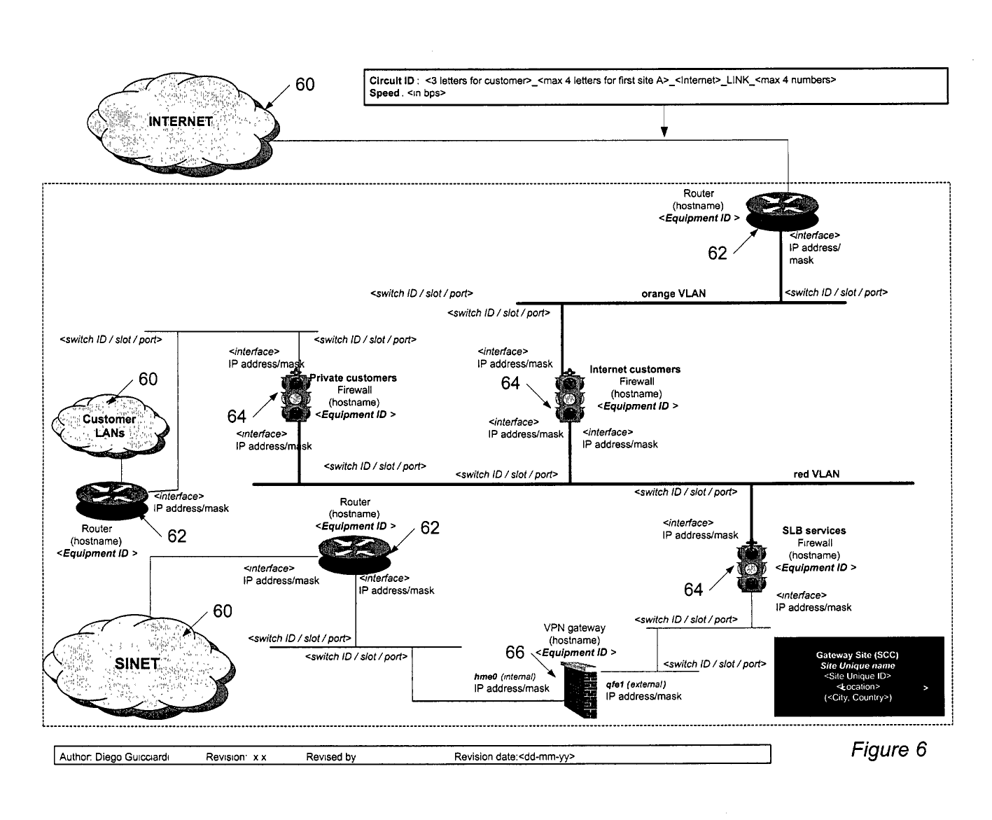

Then, for each type of site identified, a Site Architecture Map table is built (step 27). An exemplary site architecture map for a VPN solution is shown in FIG. 6 and described below. This table describes how the standard design for a site of any type should look. Those skilled in the art will appreciate that many programs exist, e.g., Visio® (registered trademark of Microsoft Corporation), that can be used to facilitate the building of a site map. This map will have to be parametric, where each parameter (e.g., hosts names, IP addresses, etc.) is filled out in the time during the different phases of the site setup and operation (survey, deployment, support). Generally, for each type of site identified, a standard highly parametric Site Architecture Map is built that will be continuously modified according to which phase of the site life cycle is used (survey, deployment, support-maintenance-upgrades).

The Site Architecture Map table should be prepared by someone that knows solution design and the layout of the particular site to be designed/setup. Normally, this person has participated in the development of the solution and site surveys. The Site Architecture Map then should be reviewed by an experienced Service Delivery and/or Service Support-Operation person to validate the design and ensure that it is clear and complete enough to allow proper support during and after the deployment is completed.

Each time a site of a given type is deployed the Global Design Architects use the Site Architecture Map to describe the detailed architecture for a particular customer site based on the information returned in the Detailed Site Survey sheet. Once done, the Global Design Architects send the Site Architecture Map back to the Site Team, who then implement the design on-site (step 28) and make modifications to the Site Architecture Map, if necessary, to reflect the final site setup (step 29).

Next, or concurrently as discussed below, additional site tables, i.e., the site notebook, Assets List table, and troubleshooting table are populated (step 30). For each type of site, a site notebook is created. The site notebook represents activity at the site and will be used (read/write) by all the members of the Solution Team. The site notebook works as a log book for what actually occurs at a given site. This allows efficient and effective review of on-site procedures. Those skilled in the art will appreciate that the site notebook is created at the onset of the project and populated as the solution progresses through the design process steps.

Another table for each type of site is the Assets list. The Assets List table contains information regarding all the assets assembled/involved in the site setup. The Assets List table will be dynamically filled and modified in real-time according to what assets (e.g., Network Elements) are deployed on a site during the project. It works as a “billing material” list during the design phase and as an “assets management tool” for later phases after the deployment as all the assets deployed on the site are easily accessible.

The Assets List table should be prepared by someone that knows solution design and the layout of the particular site to be designed/setup. Normally, this person has participated in the development of the solution and site surveys. The Assets List table then should be reviewed by an experienced Service Delivery and/or Service Support-Operation person to validate the design and ensure that it is clear and complete enough to allow proper support during and after the deployment is completed.

The Assets List table will be used Site Team (on site) who will document the relevant assets found on site during the Site Survey, by the Global Design Architects to list the assets composing the site architecture, and again by the Site Team that completes the deployment of assets on site. Further, each time an asset is added or removed from the site (e.g., upgrades, maintenance) the Site Team deploying the assets will update the Assets List table.

A Troubleshooting table is included for each type of site. This table shall contain all the information needed to effectively troubleshoot potential problems that could affect that particular type of site. The Troubleshooting table should be prepared by someone that knows global functioning of the solution (including interfaces exchanges) and how the particular site works (functionalities and interfaces). Normally, this person has participated in the development and deployment of the solution. The Assets List table then should be reviewed by an experienced Service Delivery and/or Service Support-Operation person to validate the design and ensure that it is clear and complete enough to allow proper support during and after the deployment is completed.

Network based solutions have defined types of sites, with different setups according to the role/type of the site in each particular solution. If the information needed to design, deploy, and support a particular type of site is defined, and that information is stored in an accessible table, then it becomes much easier to roll-out similar solutions using the information in the table as a template. Those skilled in the art will appreciate that the present methodology is used to facilitate the roll-out of future solutions based on previously designed and successfully piloted solutions.

The discussed site tables control information complexity on a site-by-site basis, guarantee information consistency, and maximize information re-usage between design, deployment, and support. Further, site tables can be used to rapidly transfer know how to inexperienced personnel, define and facilitate a unique worldwide approach, and guarantee information completion. The site tables are complemented with network elements tables created following similar life cycle principles. This methodology suggests a well defined organizational hierarchy for assisting the roll-out of a solution using the tables and the defined business processes.

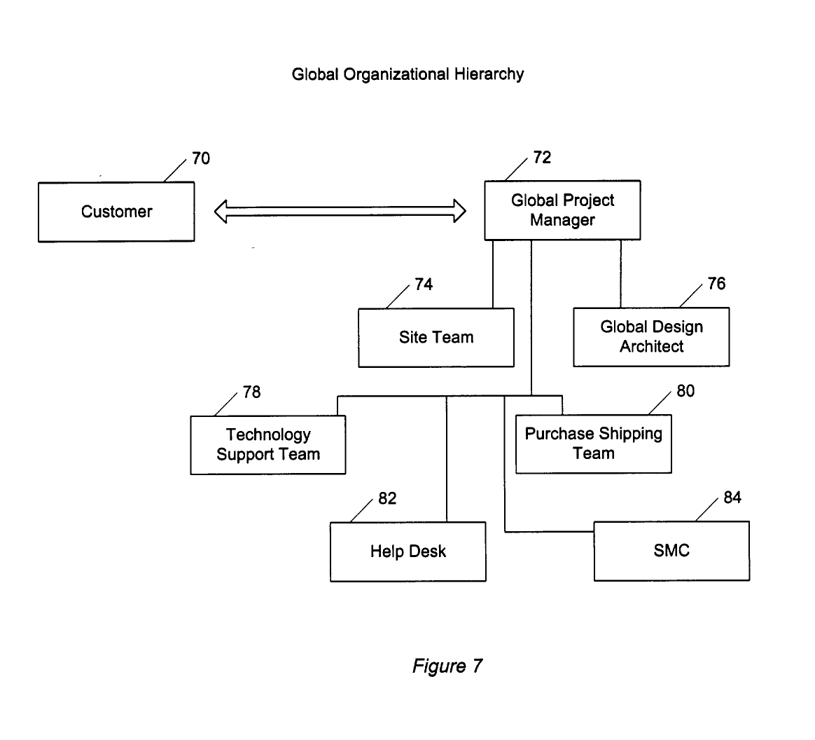

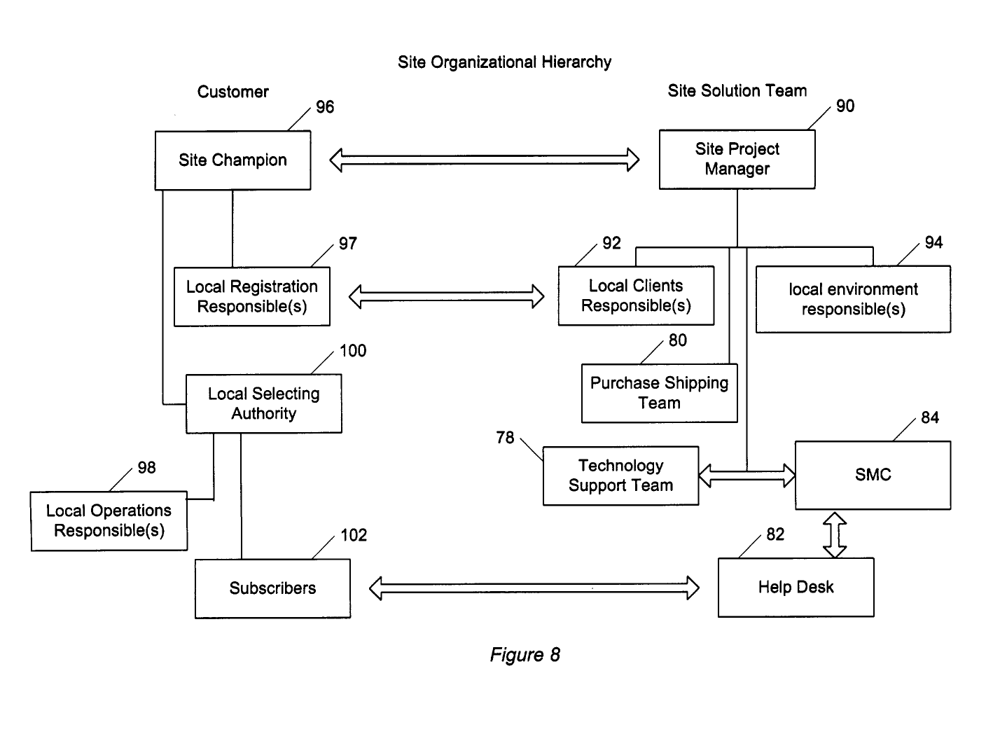

Business processes should be defined when the solution has been piloted for the first time. Typically, consultants (with possible assistance of research and development personnel) design a solution for the first time. The solution is then rolled out by a team of people organized in accordance with the organizational chart shown in FIGS. 7-8 and discussed below. After the solution is deployed, different types of sites are identified based on the design architecture of the solution. This identification is generally performed by the same people that conceived and designed the solution for the first time.

Thus, each step of the business processes should be associated with a “role” (i.e., the responsible for that step). Thus, the starting point for defining effective business processes is the chart of roles suggested by the methodology. For instance, the organizational hierarchy shown in FIGS. 7-8 aim to provide a description of who does what in a solution roll-out (independent of the type of solution). Therefore, when defining the business processes what should happen in each type of site during its complete roll-out should be described considering requirements analysis, design, delivery, operations, and support.

Also, in order to build the effective business processes, the business processes should explain how the given organization will roll-out the solution using the site tables during every phase of the Solution Life Cycle (i.e., design, deployment, operation, and support). Accordingly, at the end of a site roll-out, the site tables, business processes, and other information about the site is reviewed and certified before being stored for future use (step 31).

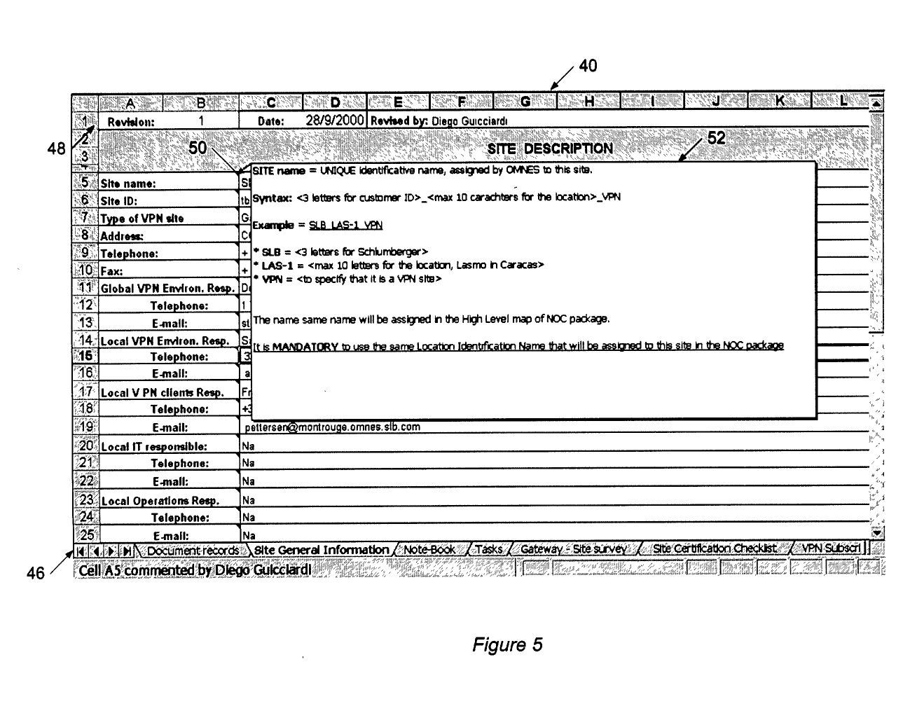

Referring to FIGS. 4-5, a screen shot (40) of an exemplary set of site tables for a VPN Gateway type site is shown. Note that the entries (42) in the first column are template fields and the entries (44) in the second column are actual site data. It can be seen that the set of site tables comprises of a number of sheets selectable by tabs (46). Also, revision information (48) showing the last user to revise, date of last revision, and revision number is included. As can be seen, each field in the site table contains a link (50). This link (50) leads to explanation (52) of the type and format of actual data to be entered.

Assets List tables are also prepared for each site. The Assets List tables contain a structured organization of the physical components involved in each site, for example, grouped by type. The Assets List tables may contain all physical network related properties, including racks, air conditioners, electric plugs, uninterruptible power supplies, etc. When a new network element is created, a hyperlink to all the related documentation kept under configuration control is supplied. For each network element, the following information should be stored: software configuration, hardware configuration, connectivity matrix, and procedures (maintenance, troubleshooting etc.). This allows a clear inventory of network element properties to be readily accessible.

A site architecture map may also be created for each site. Referring to FIG. 6, a site architecture map template is shown. The site architecture map is comprised of symbolic representations of physical network components and the connections between those components. As can be seen, various networks (60) (Internet, Customer LANs, and other dedicated networks such as SINET) are connected through routers (62), firewalls (64), and gateways (66). Also, note that descriptions of each component appear with the symbol representing it. Site architecture maps are easy to read depictions of the exact physical components and their connectivity.

Site procedures are written into documents and are stored in a documents database and will be stored following specific configuration management rules. All “useful” network related information is located in one place and logically grouped in a functional way. The three main, separated information repositories are: the Solution/Service (WAN, VPN, Corporate Badge, etc.) database, the Assets (e.g., network elements) database, and the documentation database. The Solution/Service database is mainly used and managed by Solution/Service Monitoring personnel (e.g., network analysts). The Assets database is mainly used and managed by Service Delivery personnel (e.g., network elements engineers and WAN technicians). The documentation database is used by anyone associated with the solution that creates a configuration related document.

In the Solution/Service database, as well as in the Assets database, there are hyperlinks to specific documents. All types of documents are stored in the same place and handled with the same method, e.g., check in/check out. This sensibly simplifies all necessary “backup” procedures and assures that any document produced is well stored and managed.

First, each Solution/Service (e.g., WAN) is initially described and documented from a static point of view. Then, the “methodologies for WAN performances optimization and reporting” and all related tools and documents are considered in depth and integrated in the Solution/Service Database. At a minimum, hyperlinks to troubleshooting procedures should be created for each site. Normally, many procedures should be re-usable for several sites, so that only the hyperlink should be necessary. In some situations, hyperlinks may be provided for lines or sites to the related information kept in the Solution/Service database via the Web. Specific definition of the tools and methodologies used to produce performance optimization reports for a Network Related Service or Solution will not be discussed herein. Those skilled in the art will appreciate that many tools and methodologies are known and available. For example, for a WAN, typical performance monitoring tools include HP Openview, Netcool, BMC Patrol, CiscoWorks2000, etc.

The organizational model of the solution life cycle presents a personnel hierarchy for the entire course of development, deployment, and support. Referring to FIG. 7, a global organizational hierarchy is shown. As shown, the customer (70) interacts directly with global project managers (72). A full solution life cycle is composed of three elements: design, implementation, and support. Design is normally performed by Consultants, optionally with assistance from research and design personnel. Implementation is normally performed by solution delivery personnel. Support is normally performed by Helpdesk/SMCs/solution delivery personnel. The global project manager (72) is required to manage and coordinate the above three different entities during the solution life cycle.

Under the global project manager (72), site teams (74) and global design architects (76) exist. A site team (74) is assigned to one or more sites and is responsible for gathering relevant information about a site, i.e., surveying the site, and forwarding that information to the global design architects (76). The global design architects (76) are in charge of analyzing a customer's global requirements together with the information gathered on each site in order to produce a “global design document.” The global design document must detail the global design on a site-by-site basis. After development, the global design architects (76) issue the global design document back to the site team. Then, the site team (74) is responsible for implementing the site design as described.

Finally, included in the hierarchy are technology support teams (78), purchase and shipping teams (80), help desk personnel (82), and SMC (84). Purchase and shipping teams are centralized teams in charge of purchasing and shipping any possible asset required to integrate the solution for the customer on each site. Global corporations tend to centralize this function as much as possible to save costs of personnel and high volume discounts.

Help desk personnel are a centralized support structure composed of personnel in charge of answering the calls from customers reporting some trouble/problem regarding the solution delivered. Help desk personnel follow up a trouble report by opening a ticket and trying to solve the problem remotely or helping the customer over the phone. Whenever the problem cannot be solved remotely or the Help desk personnel do not possess enough knowledge to solve it, the problem is escalated either to a Site Team or to the SMC.

An SMC (Service Management Center), also called NOC (Network Operation Center) if the service is a Network, is a set of experienced analysts working with specific tools in remote, that, via a network connection, are able to manage customer's solution assets and to identify, troubleshoot, and solve customer's problems on site. Whenever the problem cannot be solved remotely, the problem is escalated to a Site Team.

Technology support teams (78) include engineering consultants with technical knowledge about products and/or solutions. Help desk personnel (82) and SMC (84) are involved in service delivery, i.e., operations and logistics, and provide support expertise. Purchase & shipping teams (80) have commercial contracts expertise and handle purchase and delivery of solutions.

Referring to FIG. 8, a site organizational hierarchy is shown. The site team (74) is led by a site project manager (90). The site project manager (90) manages site (local) clients responsibles (92), site (local) environment infrastructure responsibles (94), as well as the technology support team (78), purchase shipping team (80), help desk personnel (82), and SMC personnel (84).

The project manager (90) organizes and supervises the successful delivery of services on site. On a site-by-site basis the project manager (90) looks at the submitted requests and evaluates the services required by the local selecting authorities. The project manger (90) assigns local environment responsible(s) on and/or local clients responsible(s) on a site-by-site basis. Also, the project manager (90) prepares a schedule for required actions (together with the local environment responsible, the local clients responsible, and the site champion), supervises the purchase and shipping of hardware and software for the site, verifies the successful completion of delivery of services to the site, and verifies the quality of the documentation produced on site, e.g., site tables. Further, the project manager (90) handles billing issues, site analysis for future business propositions, and forwarding of the site tables to the SMC after verification of quality is complete.

Local clients responsible (92) receives a schedule of required on-site actions, e.g., training, software/hardware installation, etc., contacts the local operations responsible (98) on the customer side to schedule the on-site actions, and performs the scheduled actions. For every pending subscriber in the database, hardware and software details with completion status listed are compiled. Site tables are filled in and expenses and billable hours are tracked and reported to the project manager (90). The local clients responsibles (92) typically deal with “desktop” related issues on site (e.g., install and test software on client computer, install new hardware in client computer, and the like).

The local environment responsible (94) receives a schedule of actions to be performed on-site and proceeds to the customer LAN site certification. The local environment responsible contacts the local operations responsible (98) on the customer side to schedule an on-site site survey, performs the on-site survey, and produces a LAN site certification report. Also, site tables are filled in and expenses and billable hours are tracked and reported to the project manager (90). Generally, the local environment responsibles (94) are engineers that typically deal with the local infrastructure (e.g., network, satellite, or security). For example, site infrastructure responsibles install and test routers and other networking equipment, firewalls, or satellite earth stations.

The help desk personnel (82) classify and resolve subscriber problems on a per issue basis. Help desk personnel (82) escalate problems to SMC (84) as necessary.

On the client side, a site champion (96), local registration responsibles (97), local operations responsibles (98), a local selecting authority (100), and subscribers (100) should exist.

The site champion (96) originates the request for services, agrees to a roll-out schedule and project milestones, and assigns one or more local registration authorities, local operations responsibles, and local selecting authorities for the site. The site champion may be given a unique LDAP (Lightweight Directory Access Protocol) account to access the site's administration page in the roll-out database.

Local registration authorities (97) identify the subscribers requiring a digital certificate and provide digital keys to those subscribers from a certification authority. Local operations responsibles (98) are in charge of providing logistic support to the Site Solution Team. The local operations responsibles (98) receive detailed schedules of actions to be performed on-site, facilitates the performance of the on-site actions, and handles informing subscribers of their account schedules and status. Local selecting authority (100) compiles a list of the identified subscribers for provision to the Site Solution Team and administrates the addition or suspension of subscriber accounts. Subscribers (100) are given accounts, digital certificates, and training on an as needed basis. Those skilled in the art will appreciate that these roles are exemplary and the specific tasks and responsibilities of the various roles may be shifted or amended without departing from the spirit of the present invention.

When a network is initially deployed, the global project manager (72) responsible for the project supervises the effort to ensure that all tables and databases are filled consistently. Next, during the operational phase, each site's information is managed by the site team hierarchy as described above.

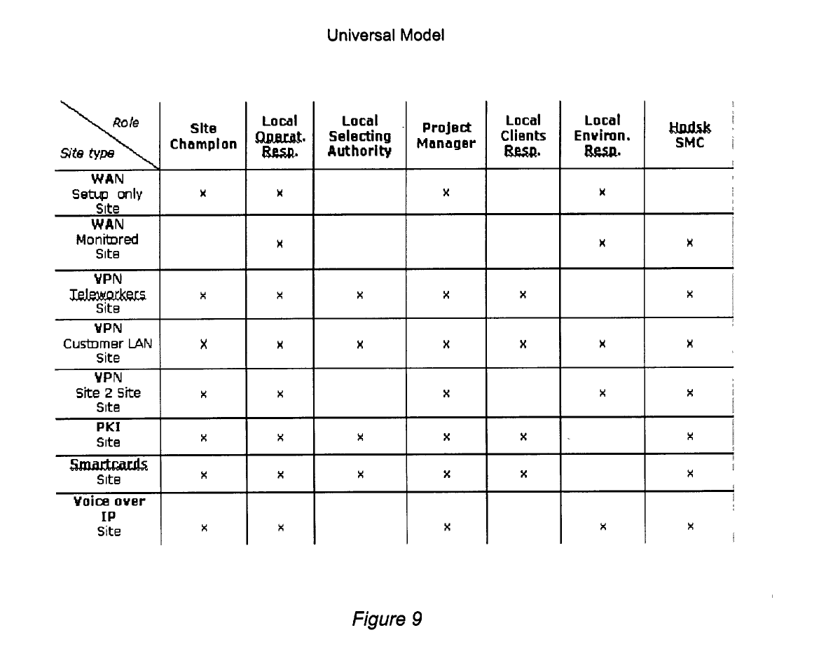

The combination of these models site methodology can be applied to any network related solution as shown in FIG. 9. The chart shown in FIG. 9 presents exemplary role assignments for different site types. The chart includes a set of common “IT Services” provided to technical consulting clients and the roles involved in a roll-out of each solution/service. The chart shows that for a list of various different “networked solutions,” the Site Life Cycle methodology organization is able to support the roll-out. As can be seen, the Site Life Cycle methodology is universally applicable to networked solutions such as those listed and other like technical solutions.

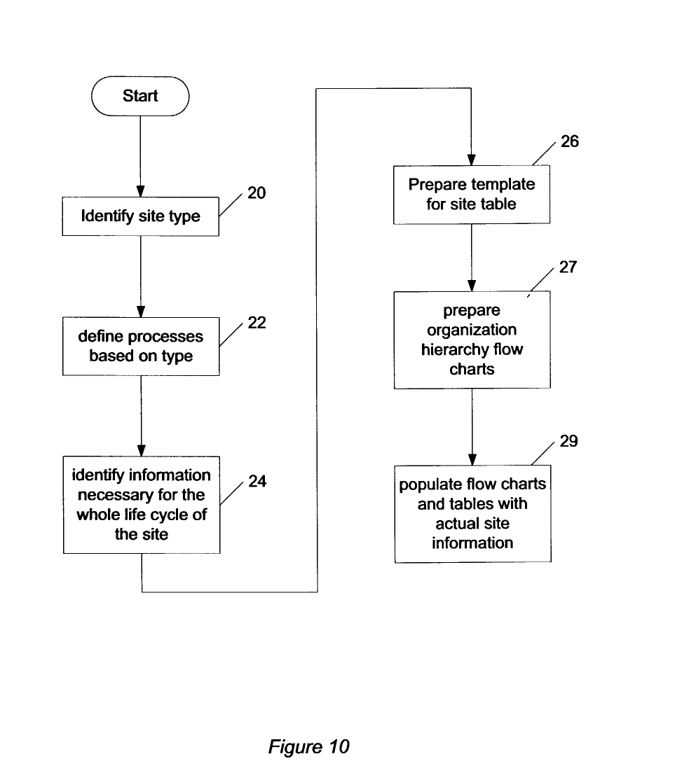

Referring to FIG. 10, for each provided network related solution, the following process should be followed. First, site tables should be created as described above. That is, the type of site being dealt with is identified (step 20). Then, for each type of site life cycle business processes are defined (step 22). These definitions may be representations using flow charts. Next, information that will be needed during the whole life cycle of the site is identified (step 24). Once information necessary for the whole life cycle is identified, a unique template, e.g., site table, is prepared (step 26). Next, the presented organizational models should be used to prepare flow charts describing how, for each business process, the organization's members interact with the site tables (27). The flow charts and site tables are then able to be populated with actual data (29) and consistently document each site during its whole life cycle.

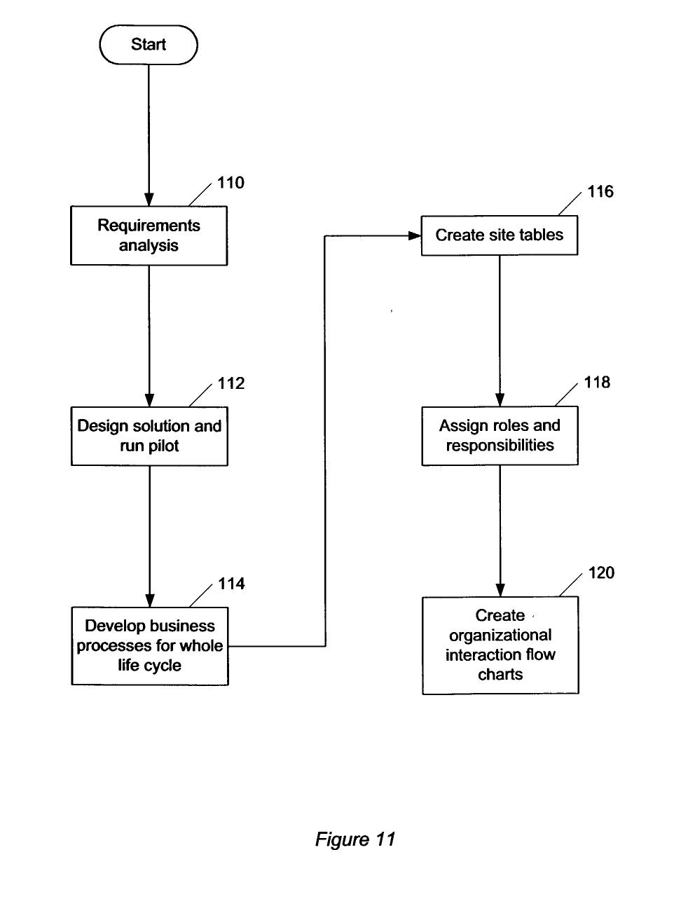

As mentioned earlier, solutions progress from design to implementation to support and maintenance. The solution life cycle methodology presented maximizes information re-usage between phases, minimizes transition time between phases, and guarantees a unique approach to information throughout all phases. A solution preparation flow chart is shown in FIG. 11. First, the customer's requirements must be understood customer (110). This information may come from a customer directly or a marketing study. Next, a solution is designed and a pilot is run (112). Then, the business processes for the complete solution life cycle are developed (114) possibly using pilot as reference. Site tables specific to the solution are created following methodology guidelines (116). Roles and responsibilities are assigned to the organization's members following the organizational hierarchy presented (118) and flow charts to describe how, for each business process, organization's members interact with the site tables (120).

The preparation phase involves all the players of the solution life cycle and ties them together. In particular, the business process development, the site table creation, and role and responsibility assignment should be performed in through workshops where all the players come together to discuss the implementation and deployment. By doing so, boundary level problems between different phases of deployment can be avoided. Further, to facilitate the creation of consistent business processes, a standard tool and standard processes should be used.

The solution life cycle methodology also helps to define and capture best practices, through the creation or improvement of site tables and flow charts. A “lessons learned” sheet can be added to the site tables and systematically returned to a methodology authority as a feedback at the end of each site project. In view of each lessons learned sheet, site tables and flow charts can improved if necessary. Best practices are kept up to date on the basis of daily field experiences.

In order to efficiently maintain the information collected using the solution life cycle methodology, a knowledge management system has been developed. The knowledge management system should involve a web interface. By doing so, customer and network information is readily available via the Internet. Further, knowledge is stored in a single secure repository, information is kept under control using configuration management techniques (such as listing for revision all tables not modified for longer then an assigned expiration period), and, in this manner, information is kept up-to-date. Distant team working and knowledge sharing among regions/business units is facilitated. Integration with other existing web-based network tools is also possible to provide a more robust or customized solution.

The solution life cycle methodology may be integrated with the use of PDAs (personal digital assistants). The site and network element tables are an ideally suited for use on PDAs. PDAs have spreadsheet applications and many have wireless Internet connections that could be used to access data in real-time (e.g., real-time wireless interaction with the knowledge management system). Alternatively, data can be uploaded/downloaded off-line via PC-PDA synchronization.

As discussed above, site clients responsibles perform desktop related tasks at a customer's site (software installs, PC adapter installation, troubleshooting, etc.). Using the solution life cycle methodology together with a knowledge management system and integrated PDA, the site clients responsibles can download task schedules from a desktop computer onto the PDA via cable synchronization. The synchronization can include the needed site/asset tables, and any other type of needed files and information. Further, the PDA can be used to store information technology support material and allow site clients responsibles access to the information in a lightweight device. PDAs can be used to document customer's acceptance/future tasks. When completed, all the data collected at the site is uploaded onto their desktop computer and, in turn, into the knowledge management system. Alternatively, if the PDA has a wireless connection, the knowledge management system can be accessed for information and updated from the site in real-time.

Similarly, a site infrastructure responsible can use a PDA to support all tasks on a site (e.g., install a network element, configure a network element). For example, using a site table loaded onto the PDA, the site infrastructure responsible can find all the needed information about the site. Any modifications made to the site/assets tables on the PDA are then sent to the knowledge management system via synchronization or wireless connection.

Advantages of using the solution life cycle methodology may include one or more of the following. The methodology presented is focused on a customer-oriented approach to solutions. By separating each customer's network into a separate entity, even for networks that physically share same circuits, it becomes possible to focus on each customer's needs and to treat each customer with a uniform approach. Moreover, all stages of the approach (documentation, reporting, etc.) become necessarily standardized and easily replicable for new customers.

The methodology integrates deterministic solution roll-outs and provides a concrete ability to forecast solution costs. The methodology is an experience packaging methodology, which provides efficient, consistent, and reliable support after deployment with a continuous focus on the customer's needs to improve any solution. Site tables are easy to scale and produce a stack that grows consistently in time. New site tables for future solutions can be more quickly prepared from previous templates.

The system provides easy to access information and is modular and scalable. Any existing or future entity that generates “useful” network information can add that information to all sites connecting to the knowledge base. Further, information replication is avoided. By having hyperlinks to information, any time a specific piece of information is needed (i.e., a document, a network element record, etc.) following the appropriate hyperlink leads to the most current information.

The methodology can be used in conjunction with PDAs to achieve accurate and efficient maintenance of sites at a low cost. Also, PDAs may be more practical in situations where laptops would be too cumbersome to use. Because the site data electronically collected in the field and, then relayed wirelessly or uploaded via synchronization with a home computer, the support process becomes more efficient. Further, installation time is reduced, while quality is increased because field engineers can enter or consult data in the PDAs in real-time in a practical way. Also, because templates are provided, the probability that new installations will be correctly documented is increased.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for designing a solution comprising:
building archival tables of information for a plurality of particular types of solution sites,
wherein the archival tables of information comprise
an assets list table describing assets deployed to each particular type of solution site; and
a site notebook describing activities involved with deployment of the assets to each particular type of solution site;
preparing archival architectural maps for each of the plurality of particular types of solution sites, the archival architectural maps describing operational connections among the assets deployed to each of the plurality of particular types of solution sites;
defining archival organization hierarchies for each of the plurality of particular types of solution sites, the archival organizational hierarchies describing roles and responsibilities for personnel involved in the development of each of the plurality of particular types of solution sites, deployment of each of the plurality of particular types of solution sites, and support of each of the plurality of particular types of solution sites;
forming a solution database containing the archival tables of information, the archival architectural maps, and the archival organization hierarchies;
surveying a new solution site to determine a particular type of the new solution site; and
designing the solution based on the particular type of the new solution site using the solution database.

2. The method of claim 1 further comprising:
creating new tables of information, new architectural maps, and a new organizational hierarchy for the new solution site; and
adding the new tables of information, new architectural maps, and new organizational hierarchy to the solution database.

3. The method of claim 1 further comprising
creating a preliminary evaluation form for each of the plurality of particular types of solution sites,
wherein the surveying of the new solution site is performed using the preliminary evaluation form.

4. The method of claim 1, the designing of the solution comprising:
defining a high level architecture based on the particular type of the new solution site using the archival tables of information, the archival architectural maps, and the archival organizational hierarchies contained in the solution database;
conducting a detailed survey of the site using the defined high level architecture; and
defining a detailed solution architecture based on the detailed survey.

5. The method of claim 2 further comprising:
implementing the designed solution at the new solution site; and
amending the new tables of information and new architectural maps for the new solution site based on the implementing of the designed solution.

6. The method of claim 2 further comprising:
storing the solution database on a central computing device;
storing copies of the new tables of information, new architectural maps, and the new organizational hierarchy on a portable device connectable to the central computing device;
amending the new tables of information, new architectural maps, and the new organizational hierarchy on the portable device at the new solution site;
updating solution database with the amended new tables of information, new architectural maps, and the new organizational hierarchy upon connection of the portable device with the central computing device.

7. The method of claim 2 further comprising:
reviewing the new tables of information, new architectural maps, and new organizational hierarchy;
selectively adding the new tables of information, new architectural maps, and new organizational hierarchy to the solution database based on the review.

8. The method of claim 2 further comprising:
supporting the designed solution;
amending the new tables of information, new architectural maps, and new organizational hierarchy as changes are made to the designed solution; and
updating the solution database with the amended new tables of information, new architectural maps, and new organizational hierarchy.

9. The method of claim 1 further comprising:
defining a global organizational hierarchy describing roles and responsibilities for personnel involved in more than one of the plurality of particular types of solution sites.

10. The method of claim 1, the archival organizational hierarchies comprising:
definitions of roles and responsibilities on a solution provider side for each of the plurality of particular types of solution sites; and
definitions of roles and responsibilities on a client side for each of the plurality of particular types of solution sites.

11. The method of claim 10, the definitions of roles and responsibilities on the solution provider side comprises:
a project manager;
local responsibles; and
technology support.

12. The method of claim 10, the definitions of roles and responsibilities on the client side comprises:
a site champion;
local responsibles; and
subscribers.

13. An apparatus for facilitating design of a solution comprising:
archival tables of information for a plurality of particular types of solution sites,
wherein the archival tables of information comprise
an assets list table describing assets deployed to each particular type of solution site; and
a site notebook describing activities involved with deployment of the assets to each particular type of solution site;
archival architectural maps for each of the plurality of particular types of solution sites, the archival architectural maps describing operational connections among the assets deployed to each of the plurality of particular types of solution sites;
archival organization hierarchies for each of the plurality of particular types of solution sites, the archival organizational hierarchies describing roles and responsibilities for personnel involved in the development of each of the plurality of particular types of solution sites, deployment of each of the plurality of particular types of solution sites, and support of each of the plurality of particular types of solution sites; and
a solution database containing the archival tables of information, the archival architectural maps, and the archival organization hierarchies,
wherein the solution is designed, based on a particular type of the new solution site determined by a survey of the new solution site, using the solution database.

14. The apparatus of claim 13 further comprising:
new tables of information, new architectural maps, and a new organizational hierarchy created for the new solution site,
wherein the new tables of information, new architectural maps, and new organizational hierarchy are added to the solution database.

15. The apparatus of claim 13 further comprising:
a preliminary evaluation form for each of the plurality of particular types of solution sites,
wherein the survey of the new solution site is performed using the preliminary evaluation form.

16. The apparatus of claim 13 further comprising:
a high level architecture defined based on the particular type of the new solution site using the archival tables of information, the archival architectural maps, and the archival organizational hierarchies contained in the solution database; and
a detailed solution architecture defined based on a detailed survey of the site conducted using the defined high level architecture.

17. The apparatus of claim 14 further comprising:
amended new tables of information, amended new architectural maps, and amended new organizational hierarchy for the new solution site representing an implementation of the designed solution at the new solution site.

18. The apparatus of claim 14 further comprising:
a central computing device for storing the solution database; and
a portable device connectable to the central computing device for storing copies of the new tables of information, new architectural maps, and the new organizational hierarchy;
wherein the new tables of information, new architectural maps, and the new organizational hierarchy are amended on the portable device at the new solution site; and
the solution database is updated with the amended new tables of information, new architectural maps, and the new organizational hierarchy upon connection of the portable device with the central computing device.

19. The apparatus of claim 14, wherein the new tables of information, new architectural maps, and new organizational hierarchy are selectively added to the solution database based on a review of the new tables of information, new architectural maps, and new organizational hierarchy.

20. The apparatus of claim 13 further comprising:
a global organizational hierarchy describing roles and responsibilities for personnel involved in more than one of the plurality of particular types of solution sites.

21. The apparatus of claim 13, the archival organizational hierarchies comprising:
definitions of roles and responsibilities on a solution provider side for each of the plurality of particular types of solution sites; and
definitions of roles and responsibilities on a client side for each of the plurality of particular types of solution sites.

22. The apparatus of claim 21, the definitions of roles and responsibilities on the solution provider side comprises:
a project manager;
local responsibles; and
technology support.

23. The apparatus of claim 21, the definitions of roles and responsibilities on the client side comprises:
a site champion;
local responsibles; and
subscribers.
